(19) United States
(12) Patent Application Publication
(10) Pub. No.: US 2010/0070165 A1
(43) Pub. Date: Mar. 18, 2010

(54) SYSTEM AND METHOD FOR PROVIDING POINT OF INTEREST IN DESTINATION AROUND

(76) Inventor: Jung Min Kang, Seoul (KR)

Correspondence Address: NIXON & VANDERHYE, PC, 901 NORTH GLEBE ROAD, 11TH FLOOR, ARLINGTON, VA, 22203, US

(21) Appl. No.: 12/516,701

(22) PCT Filed: Sep. 20, 2007
(86) PCT No.: PCT/KR07/04622

§ 371 Date: May 28, 2009

(30) Foreign Application Priority Data
Nov. 29, 2006 (KR) 10-2006-0119185

(51) Int. Cl. G01C 21/36

(52) U.S. Cl. 701/201

(57) ABSTRACT

The present invention relates to a method and system for providing a point of interest (POI) which retrieves a POI with a high search frequency from among a plurality of POIs, located within a predetermined radius from a destination requested by a user, as route-encountered statistical information, provides the route-encountered statistical information when providing a POI corresponding to the destination, and thereby may provide surrounding information frequently requested by users.

### TECHNICAL FIELD

The present invention relates to a method and system for providing a point of interest (POI) which retrieves a POI with a high search frequency from among a plurality of POIs, located within a predetermined radius from a destination requested by a user, as route-encountered statistical information, provides the route-encountered statistical information when providing a POI corresponding to the destination, and thereby may provide surrounding information frequently requested by users.

### BACKGROUND ART

A navigation system provides route information using a satellite for driving a vehicle, A navigation system includes point of interest (POI) information based on map data. POI is data displaying a station, airport, terminal, hotel, and the like, on a map using coordinates. Accordingly, a navigation system may provide route data including road information and POI based on map data on a route by considering a location of a driving vehicle.

However, most users do not find an actual destination using a keyword corresponding to the actual destination. Specifically, they first consult a map and search for a route after determining the actual destination, since a terminal or server providing a navigation service may not include all shop names and shop addresses. Accordingly, a user searches for a POI around an actual destination as a keyword to find the actual destination.

For example, when a user desires to find restaurant “A”, which is located 100 m away from exit 7 of Gangnam station, the user inputs ‘Gangnam station’ as a keyword, although any one of a shop name, telephone number, and address of restaurant “A” is actually required to be inputted as a keyword. In this instance, the user desires to go to restaurant “A”, not ‘Gangnam station’.

Thus, a service providing statistical information about frequently-searched destinations is required to be provided in a navigation system. However, when a keyword, generally used as a keyword, but not an actual destination, is calculated when compiling statistics, a frequently-searched destination is determined as ‘Gangnam station’, which is incorrect statistical information. However, when the actual destination restaurant “A”, located around ‘Gangnam station’, is calculated, a place popular with people may be ascertained. Also, when user information such as sex, age, and the like, is calculated when compiling statistics, a variety of services may be provided. As described above, a method and system for providing a POI around a destination which compiles statistics on places actually desired by users and provides route-encountered statistical information is provided.

### DISCLOSURE OF INVENTION

### Technical Goals

The present invention provides a method and system for providing a point of interest (POI) around a destination which generates route-encountered statistical information including information about places frequently searched by users, based on a POI which is selected as a destination from a plurality of POIs by a user, user information, and a number of times that the destination is selected as the POI by the users.

The present invention also provides a method and system for providing a POI around a destination which retrieves a POI corresponding to a destination, and identifies route-encountered statistical information located within a predetermined radius from the retrieved POI in order to provide a POI located around a destination searched for by a use.

### Technical Solutions

According to an aspect of the present invention, there is provided a method of providing a point of interest (POI) around a destination, including: storing a POI corresponding to a route data in a POI database; maintaining route-encountered statistical information for each category in association with the POI in a statistical information database; receiving a search request including destination information and a route-encountered category from a user; retrieving a POI corresponding to the destination information, from the POI database; identifying route-encountered statistical information which is located within a predetermined radius from the retrieved POI and associated with the route-encountered category from the statistical information database; and providing the retrieved POI and the identified route-encountered statistical information.

According to another aspect of the present invention, there is provided method of providing a POI around a destination, including: storing a POI corresponding to a route data in a POI database; receiving route-encountered information from a terminal and retrieving a POI corresponding to the route-encountered information from the POI database; providing a POI list including the retrieved POI to the terminal; receiving a POI selected from the POI list from the terminal; providing route data which provides guidance about the POT to the terminal; accumulating the POI, a category of the POI, and a number of times that the POI is selected by other users, and generating route-encountered statistical information; maintaining the generated route-encountered statistical information for each category in the statistical information database; and when a search request including a destination and a category is received from the terminal, providing route-encountered statistical information associated with the category from among route-encountered statistical information of a POI corresponding to the destination.

According to an embodiment of the present invention, there is provided a system for providing a POI, including: a POI database storing a POI corresponding to a route data; a statistical information database maintaining route-encountered statistical information for each category in association with the POI; a search request receiving unit receiving a search request including destination information and a route-encountered category from a user; an information retrieval unit retrieving a POI corresponding to the destination information from the POI database, and retrieving route-encountered statistical information which is located within a predetermined radius from the retrieved POI and associated with the route-encountered category from the statistical information database; and an information providing unit providing the retrieved POI and the retrieved route-encountered statistical information.

### BRIEF DESCRIPTION OF DRAWINGS

FIG. 1 is a diagram illustrating a network connection of a system for providing a point of interest (POI) around a destination according to an embodiment of the present invention;

FIG. 2 is a block diagram illustrating a system for providing a POI according to an embodiment of the present invention;

FIG. 3 is a diagram illustrating an example of a statistical information database according to the present invention;

FIG. 4 is a diagram illustrating an example of providing route-encountered statistical information according to an embodiment of the present invention;

FIG. 5 is a flowchart illustrating a method of generating route-encountered statistical information according to an embodiment of the present invention;

FIG. 6 is a flowchart illustrating a method of providing a POI around a destination according to an embodiment of the present invention;

FIG. 7 is a flowchart illustrating a method of generating route-encountered statistical information according to another embodiment of the present invention; and

FIG. 8 is a flowchart illustrating a method of providing a POI around a destination according to another embodiment of the present invention.

### BEST MODE FOR CARRYING OUT THE INVENTION

Hereinafter, embodiments of the present invention are described in detail by referring to the figures. However, the present invention is not limited to the embodiments of the present invention.

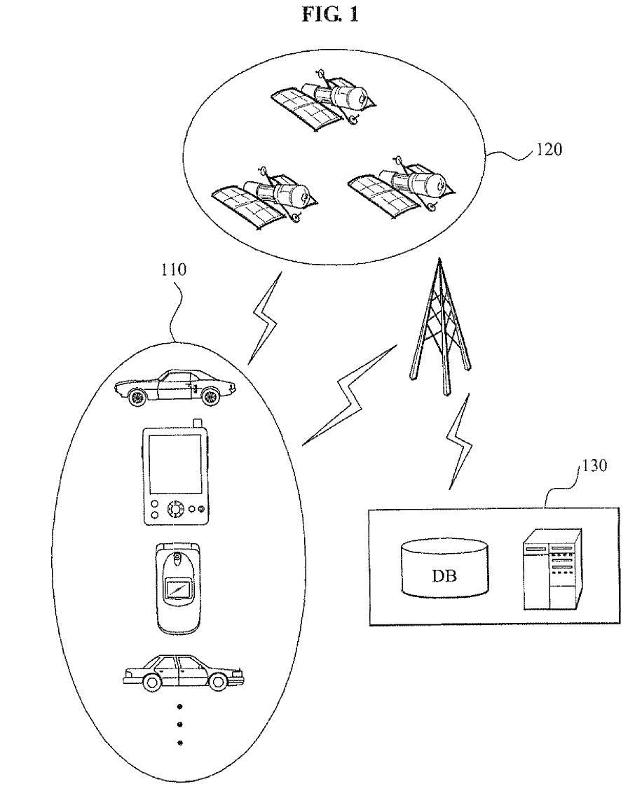

FIG. 1 is a diagram illustrating a network connection of a system 130 for providing a point of interest (POI) around a destination according to an embodiment of the present invention.

The system 130 for providing a POI provides a service about road guidance, and it is apparent that the system 130 for providing a POI may be performed in a terminal or a server. Specifically, the system 130 for providing a POI compiles statistics on a POI, frequently searched for by users from among POIs included in a particular area, for each category such as a restaurant, bar, real estate business, and the like. For this, the system 130 for providing a POI is required to search for a destination from a terminal 110 via a satellite 120, and provides a POI corresponding to the destination and route-encountered statistical information.

The system 130 for providing a POI stores a POI corresponding to a route data in a POI database. The POI is a data displaying major facilities, station, airport, hotel, and the like, on a map using coordinates. That is, the system 130 for providing a POI measures an accurate time and distance from three satellites, and calculates a location of the terminal 110 via three different distances via triangulation. Also, the system 130 for providing a POI may provide route data including road information and the POI based on a map data existing on a map by considering the calculated location of the terminal 110.

The terminal 110 receives route-encountered information from a user and transmits the route-encountered information to the system 130 for providing a POI. The route-encountered information includes any one of an address, shop name, telephone number, and a POI of the destination. In this instance, the terminal 110 may also transmit user information of the terminal 110, and the user information may include at least one of a name, address, age, sex, and contact address.

The system 130 for providing a POI retrieves a POI corresponding to the route-encountered information from the POI database. In this instance, a plurality of POIs may be retrieved according to the route-encountered information. The system 130 for providing a POI transmits a POI list including the plurality of POIs to the terminal 110.

The terminal 110 displays the POI list, receives a selection on a single POI from the user, and transmits the selected POI to the system 130 for providing a POI.

The system 130 for providing a POI provides route data providing guidance about the selected POI. That is, the system 130 for providing a POI may provide route data to the POI from a current location of the terminal 110.

Also, the system 130 for providing a POI may accumulate the selected POI, a category of the POI, the user information, and a number of times that the POI is selected by other users, and generate route-encountered statistical information. The category may be classified into a restaurant, convenience store, cosmetics store, clothing store, and the like, according to a service provided by a shop. The system 130 for providing a POI maintains the generated route-encountered statistical information for each category in association with the POI in a statistical information database. For example, the route-encountered statistical information includes information about “Levis (shop name)” corresponding to “restaurant (category), twenties (age), female (sex), 50 times (selection frequency)” with respect to a POI “Gangnam station”. The system 130 for providing a POI stores the generated route-encountered statistical information in the statistical information database.

Then, when receiving a search request including destination information and a route-encountered category from the terminal 110, the system 130 for providing a POI may retrieve a POI corresponding to the destination information and route-encountered statistical information, and provide the POI and the route-encountered statistical information to the terminal 110. The route-encountered statistical information is located within a predetermined radius from the retrieved POI and associated with the route-encountered category.

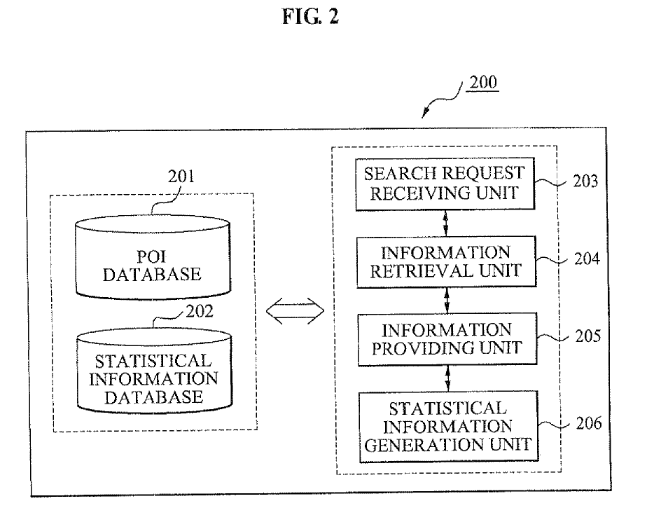

Hereinafter, a configuration of the system 130 for providing a POI is described in detail with reference to FIG. 2.

FIG. 2 is a block diagram illustrating a system 200 for providing a POI according to an embodiment of the present invention.

As illustrated, the system 200 for providing a POI includes a POI database 201, a statistical information database 202, a search request receiving unit 203, an information retrieval unit 204, an information providing unit 205, and a statistical information generation unit 206.

The POI database 201 stores a POI corresponding to a route data. The route data includes road information and a POI based on map data. The road information includes information about road types such as art express way, and national highway, and a traffic lane such as one lane, two lanes, four lanes, and the like. The road information may be updated at regular intervals according to a lane change, newly-built road, location-changed road, and the like. Also, the POI is data displaying on a map using coordinates. For example, “subway station at Jongro 3”, “Seoul theater”, “National tax service”, and the like, based on ‘Jongro’ area may be a POI.

The statistical information database 202 maintains route-encountered statistical information for each category in association with the POI. The route-encountered statistical information is statistical information about a POI, frequently searched for by users, from among POIs included in a particular area for each category.

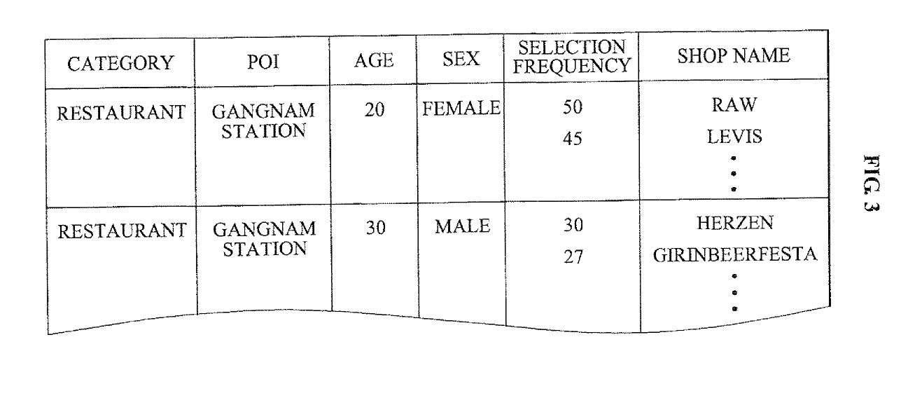

Referring to FIG. 3, the statistical information database 202 stores the route-encountered statistical information including a category, POI, age, sex, selection frequency, and shop name. The category may be classified into a restaurant, bar, convenience store, cosmetics store, clothing store, and the like, according to a service provided by a shop. The POI is a POI (Gangnam station) belonging to the category in a particular area, and the age (20 or 30) and the sex (female or male) is user information of a user selecting the shop name. The selection frequency (50 or 30) is obtained by accumulating a number of times that a route guidance is requested with respect to the shop name. The shop name (Raw or Herzen) is a name of a place most popular with users from among restaurants in the particular area. The statistical information database 202 may store coordinates associated with the shop name to provide the route data when the user inputs the shop name as a destination.

The statistical information generation unit 206 accumulates the POI selected by the users, a category of the POI, user information of the user selecting the POI, and a number of times that the POI is selected by other users, and generates the route-encountered statistical information in order to provide the route-encountered statistical information. That is, the statistical information generation unit 206 may ascertain places popular with the users and located in a particular POI, compile statistics on the places according to the category, sex, and age, and generate the route-encountered statistical information. Also, the statistical information generation unit 206 may regenerate route-encountered statistical information of POI for each category for a predetermined period and update the regenerated route-encountered statistical information to the statistical information database 202, since the route-encountered statistical information may change depending on usage pattern of users due to a nature of the present invention. Accordingly, better information may be provided by updating the route-encountered statistical information at every predetermined period.

The search request receiving unit 203 receives a search request including destination information and a route-encountered category from the user. The destination information may be a POI, for example, “Gangnam station”, “City hall of Seoul”, and “Sejong performing art center”. The route-encountered category may be an item name of places to be found based on the destination information, for example, “restaurant”, “popular restaurant”, “beauty shop”, “shop”, and the like. When the user desires to know popular restaurants around Gangnam station, the user may request for a search by inputting “popular restaurants around Gangnam station” as a keyword.

The information retrieval unit 204 retrieves a POI corresponding to the destination information from the POI database 201, and identifies route-encountered statistical information which is located within a predetermined radius from the retrieved POI and associated with the route-encountered category from the statistical information database 202. For example, when “popular restaurants around Gangnam station” is requested to be retrieved, “Gangnam station” is retrieved as the POI, and popular restaurants, that is, restaurants where a large number of people frequently go, from among “restaurants” located within a 5 km radius from the Gangnam station is retrieved. The radius identifying the route-encountered statistical information may be set by the user when requesting, or set in the system 200 for providing a POI.

The information providing unit 205 provides the retrieved POI and the route-encountered statistical information. In this instance, the information providing unit 205 may provide top route-encountered statistical information being statistically high in occurrences from among the identified route-encountered statistical information. For example, top five restaurants from among the “popular restaurants around Gangnam station” may be provided. As described above, a number of POIs provided as the route-encountered statistical information may be set by the user when requesting, or set in the system 200 for providing a POI.

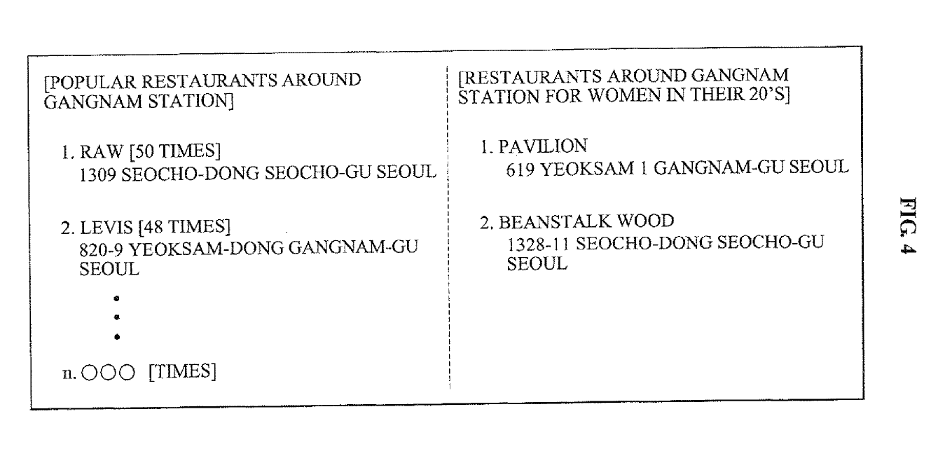

Referring to FIG. 4, when “popular restaurants around Gangnam station” is requested to be retrieved by the user, the information providing unit 205 may provide “Raw, 1309 Seocho-dong Seocho-gu Seoul”, “Levis, Yeoksam-dong Gangnam-gu Seoul”, and the like as the route-encountered statistical information. In this instance, the information providing unit 205 may provide route data providing guidance about a route to “Raw” from a current location of the user.

The search request receiving unit 203 may receive the destination information and route-encountered category as well as age information and sex information when requested. In this instance, the information retrieval unit 204 retrieves route-encountered statistical information associated with the age information and sex information from the statistical information database 202.

For example, when “popular restaurants around Gangnam station” is requested to be retrieved by the user to ascertain places popular with people in a particular age range, the information retrieval unit 204 may search for “restaurant” classified under “Gangnam station” and “twenties” from the statistical information database 202. Also, when “restaurants, popular with women, around Gangnam station” is requested to be retrieved by the user, the information retrieval unit 204 may search for “restaurant” classified under “Gangnam station” and “women” from the statistical information database 202. Also, when “restaurants around Gangnam station for women in their twenties” is requested to be retrieved by the user, the information retrieval unit 204 may search for “restaurant” classified under “Gangnam station”, “twenties”, and “women” from the statistical information database 202. As described with reference to FIG. 3, since the route-encountered statistical information stores a shop name associated with a category, POI, and user information (age, sex), the search described above may be performed.

Accordingly, the information providing unit 205 may provide the retrieved route-encountered statistical information. Referring to FIG. 4, when “restaurants around Gangnam station for women in their twenties” is requested to be retrieved by the user, the information providing unit 205 may provide “Pavilion, 619 Yeoksam 1 Gangnam-gu Seoul”, “Beanstalk wood, Seocho-dong Seocho-gu Seoul”, and the like, as the route-encountered statistical information.

According to the present invention, the route-encountered statistical information is maintained based on the user information, and thus the top route-encountered statistical information being statistically high in occurrences due to a popularity with people in a particular age range from among a plurality of POIs included in a particular area may be provided.

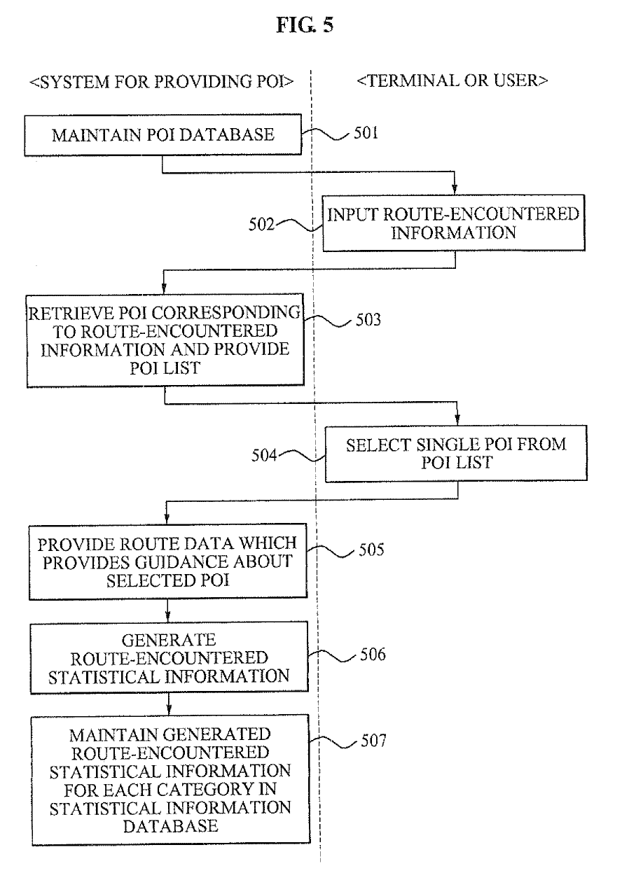

FIG. 5 is a flowchart illustrating a method of generating route-encountered statistical information according to an embodiment of the present invention. The method of generating route-encountered statistical information may be performed by the system 200 for providing a POI illustrated in FIG. 2.

In operation S501, a POI corresponding to a route data is stored in the POI database 201 of the system 200 for providing a POI. The route data includes road information and POI based on map data. Also, the POI is data displayed on a map using names, for example, “Jongro 3”, “Coex”, and the like.

In operation S502, a terminal or a user inputs route-encountered information in the system 200 for providing a POI. The route-encountered information is any one of an address, shop name, telephone number, and POI of a destination. For example, the terminal or user may input “Yeoksam-dong Gangnam-gu Seoul (address)”, “Levis (shop name)”, “02-123-4567 (telephone number)”, and “Gangnam station (POI)” as the route-encountered information.

When the system 200 for providing a POI is a server, the route-encountered information is received from the terminal, and the system 200 for providing a POI is installed in the terminal, the route-encountered information may be received from the user via a predetermined input device. In this instance, the system 200 for providing a POI may receive user information as well as the route-encountered information. The user information may include at least one of a name, address, age, sex, and contact number.

In operation S503, the information retrieval unit 204 retrieves a POT corresponding to the route-encountered information from the POI database 201, and the information providing unit 205 provides a POI list including the retrieved POI. In this instance, a plurality of POIs may be retrieved depending on the route-encountered information.

In operation S504, the terminal or user receives the POI list and selects a single POI from the user. The POI list includes the plurality of POIs, and the plurality of POIs and address may be displayed.

In operation S505, the information providing unit 205 provides a route data providing guidance about the selected POI. That is, the information providing unit 205 may provide the route data by including road information and POI in map data to the POI from a current location of the user.

In operation S506, the statistical information generation unit 206 accumulates the selected POI, a category of the POI, the user information, and a number of times that the POI is selected by other users, and generates route-encountered statistical information. In operation S507, the statistical information generation unit 206 stores the route-encountered statistical information for each category in association with the POI in a statistical information database 202, by referring to FIG. 3.

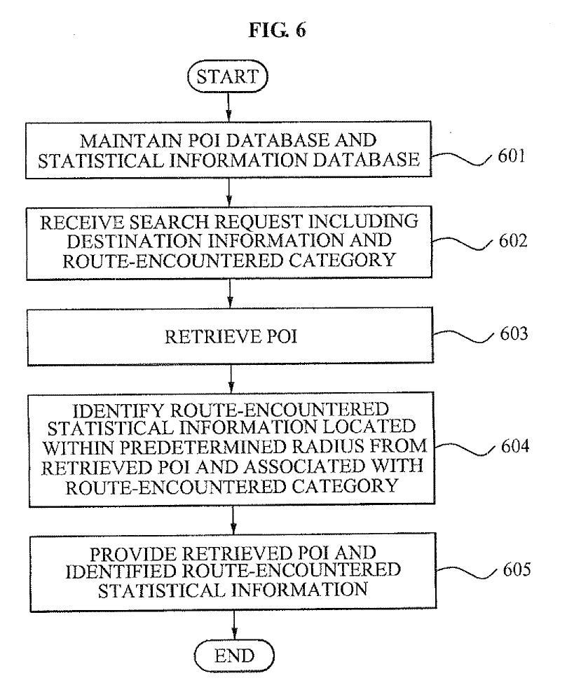

FIG. 6 is a flowchart illustrating a method of providing a POI around a destination according to an embodiment of the present invention. The method of providing a POI around a destination may be performed by the system 200 for providing a POI illustrated in FIG. 2.

In operation S601, the system 200 for providing a POI maintains the POI database 201 storing a POI and the statistical information database 202 storing route-encountered statistical information.

In operation S602, the search request receiving unit 203 receives a search request including destination information and a route-encountered category from a user. The destination information may be the POI and the route-encountered category may be an item name of places to be retrieved based on the destination information. For example, when the user desires to know popular restaurants around Gangnam station, the user may request for a search by inputting “popular restaurants around Gangnam station” as a keyword.

In operation S603, the information retrieval unit 204 retrieves a POI corresponding to the destination information from the POI database 201.

In operation S604, the information retrieval unit 204 identifies route-encountered statistical information which is located within a predetermined radius from the retrieved POI and associated with the route-encountered category from the statistical information database 202. The radius identifying the route-encountered statistical information may be set by the user when requesting, or set in the system 200 for providing a POI.

In operation S605, the information retrieval unit 204 provides the retrieved POI and the route-encountered statistical information. In this instance, the information retrieval unit 204 may provide top route-encountered statistical information being statistically high in occurrences from among the identified route-encountered statistical information.

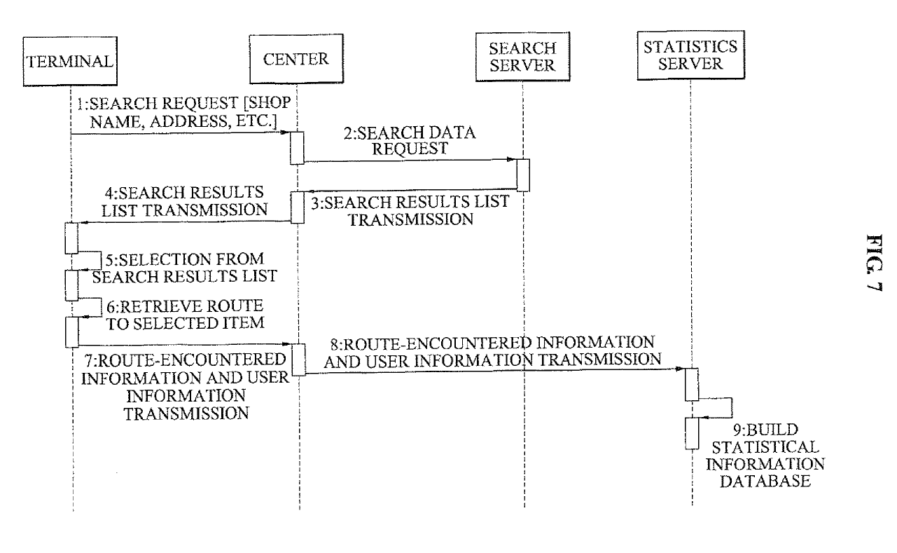

FIG. 7 is a flowchart illustrating a method of generating route-encountered statistical information according to another embodiment of the present invention.

As illustrated, in operation 1, a terminal receives an address, shop name, and the like, from a user, and requests a center for a search. In operation 2, the center requests a search server for search data including the address, shop name, and the like. In operation 3, the search server retrieves a POI corresponding to the search data by referring to a POI database, and transmits a search results list to the center. In operation 4, the center transmits the search results list to the terminal. In operation 5, the terminal selects an item to be retrieved from the search results list. Accordingly, in operation 6, the terminal retrieves a route to the selected item. In operation 7, the terminal transmits route-encountered information and user information to the center. In operation 8, the center transmits the route-encountered information and the user information to a statistics server. In operation 9, the statistics server builds a statistics information database. The statistics server may generate route-encountered statistical information based on the route-encountered information and the user information and build the statistics information database.

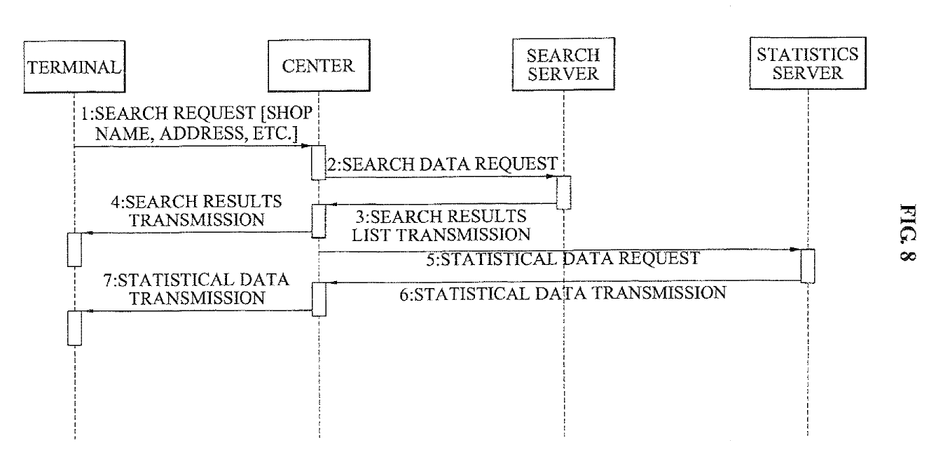

FIG. 8 is a flowchart illustrating a method of providing a POI around a destination according to another embodiment of the present invention.

As illustrated, in operation 1, a terminal transmits an address, shop name, and the like, from a user to a center, and requests the center for a search. In operation 2, the center requests a search server for search data including the address, shop name, and the like. In operation 3, the search server retrieves a POI corresponding to the search data by referring to a POI database, and transmits a search results list to the center. In operation 4, the center transmits the search results list to the terminal. In operation 5, the terminal requests a statistics server for a statistics data. In operation 6, the statistics server retrieves statistics data by referring to a statistics information database, and transmits the statistics data to the center. In operation 7, the center transmits the statistics data to the terminal. Accordingly, the terminal may provide a user with a search results on the requested POI and the statistics data.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

According to the present invention, a method and system for providing a point of interest (POI) around a destination generates route-encountered statistical information including information about places frequently searched by users, based on a POI which is selected as a destination from a plurality of POIs by a user, user information, and a number of times that the destination is selected as the POI by the users.

Also, according to the present invention, a method and system for providing a POI around a destination retrieves a POI corresponding to a destination, and identifies route-encountered statistical information located within a predetermined radius from the retrieved POI in order to provide a POI located around a destination searched for by a user.

Also, according to the present invention, a method and system for providing a POI around a destination maintains route-encountered statistical information based on user information, and thereby may provide top route-encountered statistical information being statistically high in occurrences due to a popularity with people in a particular age range from among a plurality of POIs included in a particular area.

1.-18. (canceled)

19. A method of providing a point of interest (POI) around a destination, comprising:
storing a POI corresponding to a route data in a POI database;
maintaining route-encountered statistical information for each category in association with the POI in a statistical information database;
receiving a search request including destination information and a route-encountered category from a user;
retrieving a POI corresponding to the destination information, from the POI database;
identifying route-encountered statistical information which is located within a predetermined radius from the retrieved POI and associated with the route-encountered category from the statistical information database; and
providing the retrieved POI and the identified route-encountered statistical information.

20. The method of claim 19, wherein the maintaining comprises:
receiving route-encountered information from the user and retrieving a plurality of POIs corresponding to the route-encountered information from the POI database;
providing a POI list including the plurality of POIs;
receiving a selection of a single POI from the POI list, from the user;
providing route data which provides guidance about the selected POI;
accumulating the selected POI, a category of the POI, user information of the user selecting the POI, and a number of times the POI is selected by other users, and generating route-encountered statistical information; and
maintaining the generated route-encountered statistical information for each category in the statistical information database.

21. The method of claim 19, wherein the route-encountered statistical information includes sex information, and is maintained in the statistical information database, and the identifying of the route-encountered statistical information comprises identifying the route-encountered statistical information from the statistical information database by considering the sex information when a search request including the sex information is received.

22. The method of claim 19, wherein the route-encountered statistical information includes age information, and is maintained in the statistical information database, and the identifying of the route-encountered statistical information comprises identifying the route-encountered statistical information from the statistical information database by considering the age information when a search request including the age information is received.

23. The method of claim 19, wherein the route-encountered statistical information includes sex information and age information and is maintained in the statistical information database, and the identifying of the route-encountered statistical information comprises identifying the route-encountered statistical information from the statistical information database by considering the age information and the sex information when a search request including the age information and the sex information is received.

24. The method of claim 19, wherein the providing of the route-encountered statistical information comprises providing top route-encountered statistical information being statistically high in occurrences from among the identified route-encountered statistical information.

25. A method of providing a POI around a destination, comprising:
storing a POI corresponding to a route data in a POI database;
receiving route-encountered information from a terminal and retrieving a POI corresponding to the route-encountered information from the POI database;
providing a POI list including the retrieved POI to the terminal;
receiving a POI selected from the POI list from the terminal;
providing route data which provides guidance about the POI to the terminal;
accumulating the POI, a category of the POI, and a number of times that the POI is selected by other users, and generating route-encountered statistical information;
maintaining the generated route-encountered statistical information for each category in the statistical information database; and
when a search request including a destination and a category is received from the terminal, providing route-encountered statistical information associated with the category from among route-encountered statistical information of a POI corresponding to the destination.

26. A computer-readable recording medium storing a program for implementing the method according to claim 19.

27. A system for providing a POI, comprising:
a POI database storing a POI corresponding to a route data;
a statistical information database maintaining route-encountered statistical information for each category in association with the POI;
a search request receiving unit receiving a search request including destination information and a route-encountered category from a user;
an information retrieval unit retrieving a POI corresponding to the destination information from the POI database, and retrieving route-encountered statistical information which is located within a predetermined radius from the retrieved POI and associated with the route-encountered category from the statistical information database; and
an information providing unit providing the retrieved POI and the retrieved route-encountered statistical information.

28. The system of claim 27, wherein:
the information retrieval unit receives route-encountered information from the user and retrieves a plurality of POIs corresponding to the route-encountered information from the POI database, and
the information providing unit further comprises a statistical information generation unit providing a POI list including the plurality of POIs, when a single POI is selected by the user from the POI list, providing route data which provides guidance about the selected POI, accumulating the selected POI, a category of the POI, user information of the user selecting the POI, and a number of times that the POI is selected by other users, and generating route-encountered statistical information.

29. The system of claim 28, wherein the statistical information database maintains sex information corresponding to the route-encountered statistical information based on the user information, and the information retrieval unit retrieves route-encountered statistical information corresponding to the sex information from the statistical information database when a search request including the sex information is received.

30. The system of claim 28, wherein the statistical information database maintains age information corresponding to the route-encountered statistical information based on the user information, and the information retrieval unit retrieves route-encountered statistical information corresponding to the age information from the statistical information database when a search request including the age information is received.

31. The system of claim 28, wherein the statistical information database maintains age information and sex information corresponding to the route-encountered statistical information based on the user information, and the information retrieval unit retrieves route-encountered statistical information corresponding to the age information and the sex information from the statistical information database when a search request including the age information and the sex information is received.

32. The system of claim 31, wherein the information providing unit provides top route-encountered statistical information with a high search frequency from among the route-encountered statistical information.

33. A system for providing a POI, comprising:
a POI database storing a POI corresponding to a route data;
an information receiving unit receiving route-encountered information from a terminal;
an information retrieving unit retrieving a POI corresponding to the route-encountered information from the POI database;
an information providing unit providing a POI list including the retrieved POI to the terminal, and providing route data which provides guidance about the POI of the POI list to the terminal;
a statistical information generation unit accumulating the POI, a category of the POI, and a number of times that the POI is selected by other users, and generating route-encountered statistical information; and
a statistical information database storing the generated route-encountered statistical information for each category.
